(19) United States
(12) Patent Application Publication
(10) Pub. No.: US 2014/0085895 A1
(43) Pub. Date: Mar. 27, 2014

(54) LED Bracket Apparatus for High-Output LED Lighting Systems

(71) Applicant: Thomas Frawley, Woodstock, IL (US)

(72) Inventor: Thomas Frawley, Woodstock, IL (US)

(21) Appl. No.: 13/968,639

(22) Filed: Aug. 16, 2013

Related U.S. Application Data
(60) Provisional application No. 61/683,801, filed on Aug. 16, 2012.

(51) Int. Cl. F21K 99/00

(52) U.S. Cl. CPC F21K 9/10
USPC 362/249.03

(57) ABSTRACT

A bracket holds high-output LED lighting systems within existing light fixtures, such as, for example, shoe box parking lot fixtures, gas station canopy fixtures, and street light fixtures. Specifically, the bracket is adjustable to fit most light fixture housings so that the light fixture housings can be retrofitted and orientated with the high-output LED lighting systems without removal or replacement of components thereof, such as the housing, the cover, the lens, and/or other like components.

This application claims the benefit of U.S. provisional application Ser. No. 61/683,801 filed on Aug. 16, 2012 and is incorporated by reference herein in its entirety.

### TECHNICAL FIELD

The present invention relates to a bracket apparatus for holding high-output LED lighting systems within existing light fixtures, such as, for example, shoe box parking lot fixtures, gas station canopy fixtures, street light fixtures and other like high output lighting fixtures. Specifically, the bracket is adjustable for allowing the plate to fit most light fixture housings so that the light fixture housings can be retrofitted and orientated with the high-output LED lighting systems without removal or replacement of components thereof, such as the housing, the cover, the lens, and/or other like components.

### BACKGROUND

It is, of course, generally known to utilize high-output lighting fixtures for lighting. Indeed, high-output lighting is used to illuminate streets and highways, parking lots, gas stations, businesses, and other like areas. A lighting fixture of this nature generally includes a source of light mounted and raised on a pole over an area to be illuminated. Typically, the lighting fixture is angled downwardly to illuminate an area therebeneath. Typically, the lighting is important for safety and security, as well as providing a source of illumination for aiding visual perception during the night.

Street lights have been used for thousands of years to provide illumination and security. Romans used oil lamps to illuminate streets or areas outside of homes. Throughout time, other light sources have been used, such as candles, gas, and electricity. As time has progressed into the modern era, high-output illumination sources have been developed that effectively provide illumination to areas at night or in otherwise darkened areas, such as parking garages and the like, to provide effective visual perception aid and increased safety and security.

Typically, modern street lights utilize high-intensity discharge lamps to provide illumination, such as, for example, high pressure sodium lamps, metal halide lamps or mercury lamps. One major issue with modern street lights utilizing typical high intensity discharge lamps is simply the color of the light that is output. It is generally known that certain light colors, such as white light, for example, provide individuals with better visual perception than other colors. However, it can be very difficult to create a proper light color using typical high-intensity discharge lamps.

Moreover, while these high intensity discharge lamps may provide sufficient illumination to be used as street, parking of gas station lights, they typically consume a relatively large amount of power when activated and are highly inefficient. Thus, precious resources may be wasted to provide the necessary illumination, safety and security, not only in the United States, but around the world.

Indeed, many roads, highways, parking lots, parking garages, gas stations, and other like areas are illuminated across the world. Thus, millions of lighting fixtures are utilized to provide this illumination. The waste and inefficiency of typical high intensity lighting sources is thus multiplied millions of times.

In addition, typical high intensity discharge lamps utilized for high output illumination have a relatively short lifespan, meaning that they must be replaced relatively frequently when they fail. Disposal of spent lamps may pose an issue, as certain high output lamps may contain hazardous material, such as, for example, mercury vapor, that must be disposed of properly or cause environment problems.

A modern solution to the use of typical high output lamps is to utilize high output LED lighting sources to provide the proper illumination. LED lighting generally has the benefits of providing sufficient illumination intensity at desired light colors while being highly efficient and lasting significant periods of time. Thus, LED lighting solutions may solve many of the problems associated with typical high intensity lamps currently in use around the United States and the world.

For example, Philips Electronics has a line of high intensity LED lighting modules that may be utilized for street lights, parking areas, gas stations and the like. Specifically, Philips Fortimo LED High Brightness Module is a compact rectangular light engine with a non-integrated driver that is offered as several different products, including differences in wattage (either 54 W or 35 W), and different color temperatures. The Philips Fortimo LED High Brightness Modules generally have a compact design, and are cost-effective, allowing efficiencies of up to 115 lumens per watt. Generally, the Philips Fortimo LED High Brightness Modules have a high lumen output from a relatively small, compact light engine.

Installation of LED lighting sources for areas of new construction may be relatively easy, in the sense that a light fixture may be created and installed specific for the LED lighting source. However, as millions of light fixtures currently exist and are utilized for illuminating the world, it would be more efficient and cost effective to retrofit existing light fixtures, thereby replacing the typical high output lamps with the highly efficient LED light sources. A need, therefore, exists for apparatuses, systems and methods for effectively retrofitting current light fixtures with highly efficient LED light sources.

However, it can be very difficult to effectively retrofit existing light fixtures with the highly efficient LED light sources. There are many, many types of fixtures for providing illumination, including shoe box fixtures, which are relatively small, canopy light fixtures, which may be relatively large, and street light fixtures which may come in many shapes and sizes. Therefore, each retrofit installation may pose its own unique challenges because of differences in size and shape of the fixtures. Heretofore known solutions for retrofitting these existing light fixtures are ad hoc, in that each light fixture is handled on a separate and individual basis. Thus, a need exists for apparatuses, systems and methods for effectively retrofitting existing light fixtures with highly efficient LED light sources that may be utilized for light fixtures of many different shapes and/or sizes.

Moreover, existing light fixtures may pose other unique problems, including differences in electricity source design, proper cooling and airflow designs, and other problems. Thus, a need exists for apparatuses, systems and methods for effectively retrofitting existing light fixtures with highly efficient LED light sources that may be utilized in fixtures having other unique problems, such as electricity source issues, proper cooling and airflow designs, and other like problems.

Because there exists a lack of apparatuses, systems and methods for effectively installing LED light sources in existing light fixtures, the time required to install LED light sources in existing light fixtures is inordinate. Therefore, a need exists for apparatuses, systems and methods for quickly and easily retrofitting of light fixtures with highly efficient LED light sources.

### SUMMARY OF THE INVENTION

The present invention relates to a bracket for holding high-output LED lighting systems within existing light fixtures, such as, for example, shoe box parking lot fixtures, gas station canopy fixtures, and street light fixtures. Specifically, the bracket is adjustable to fit most light fixture housings so that the light fixture housings can be retrofitted and orientated with the high-output LED lighting systems without removal or replacement of components thereof, such as the housing, the cover, the lens, and/or other like components.

To this end, in an embodiment of the present invention, an apparatus is provided for retrofitting a light fixture having a shape and size with one or more LED modules, comprising an adjustable bracket having a first arm and a second arm, and a high output LED module disposed between the first arm and the second arm, wherein the first arm and the second arm are adjustable toward the LED module and away from the LED module to fit the size and shape of the light fixture.

The apparatus incorporates two sets of sleeves at right angles to each other (ninety degrees) which accommodate the adjustable bracket arms. The two sets of sleeves at right angles to each other allow the apparatus to be installed in one of two preferential orientations. It is an advantage and objective of the present invention to provide an ideal orientation of the high output LED module which optimizes light output and general aesthetics.

It is, therefore, an advantage and objective of the present invention to provide apparatuses, systems and methods for effectively retrofitting current light fixtures with highly efficient LED light sources.

Moreover, it is an advantage and objective of the present invention to provide apparatuses, systems and methods for effectively retrofitting existing light fixtures with highly efficient LED light sources that may be utilized for light fixtures of many different shapes and/or sizes.

In addition, it is an advantage and objective of the present invention to provide apparatuses, systems and methods for effectively retrofitting existing light fixtures with highly efficient LED light sources that may be utilized in fixtures having other unique problems, such as electricity source issues, proper cooling and airflow designs, and other like problems.

Further, it is an advantage and objective of the present invention to provide apparatuses, systems and methods for quickly and easily retrofitting of light fixtures with highly efficient LED light sources.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an LED bracket apparatus in an embodiment of the present invention.

FIGS. 2A-2D illustrate components of an LED bracket apparatus in an embodiment of the present invention.

FIGS. 3A-3K illustrate components and a method of attaching an LED bracket apparatus in an embodiment of the present invention.

FIGS. 4A-4C illustrate components and an alternate method of attaching an LED bracket apparatus in an embodiment of the present invention.

FIGS. 5A-5D illustrate an alternate LED bracket apparatus in an embodiment of the present invention.

FIG. 6 illustrates an alternate LED bracket apparatus for a round light fixture in an embodiment of the present invention.

FIG. 7 illustrates an alternate orientation of the LED bracket apparatus.

### DETAILED DESCRIPTION OF THE PRESENTLY PREFERRED EMBODIMENTS

The present invention relates to a bracket for holding high-output LED lighting systems within existing light fixtures, such as, for example, shoe box parking lot fixtures, gas station canopy fixtures, and street light fixtures. Specifically, the bracket is adjustable to fit most light fixture housings so that the light fixture housings can be retrofitted with the high-output LED lighting systems without removal or replacement of components thereof, such as the housing, the cover, the lens, and/or other like components.

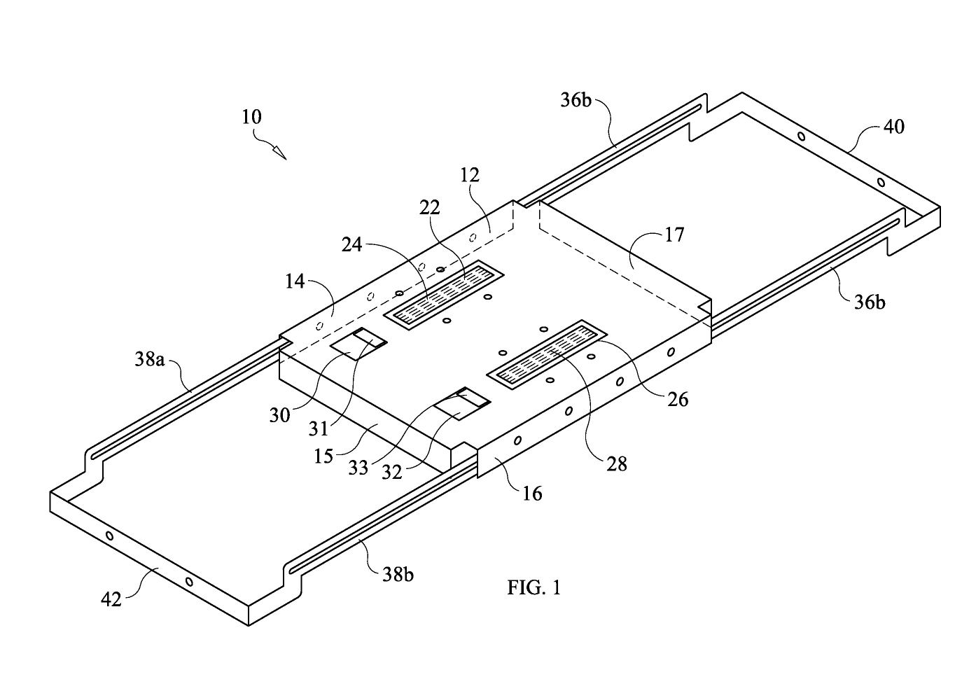

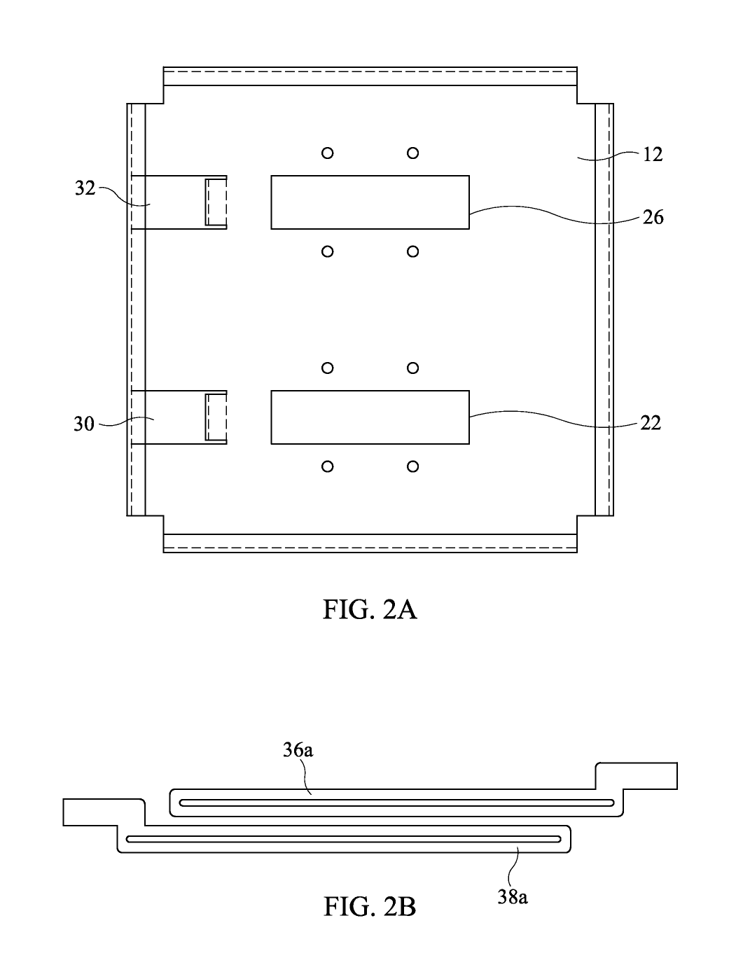

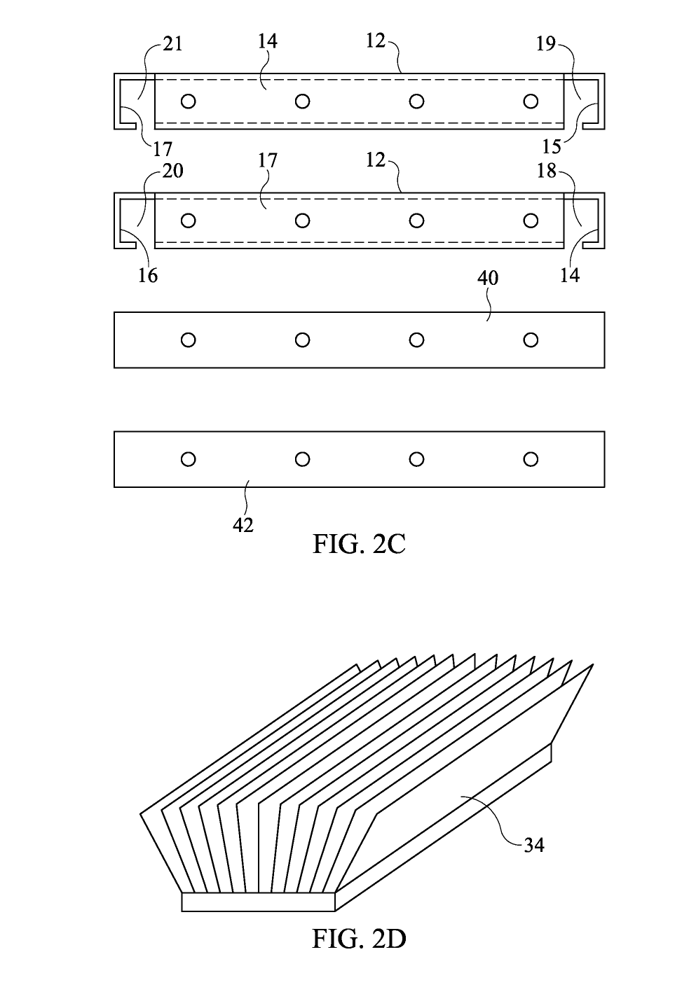

Now referring to the figures, wherein like numerals refer to like parts, FIG. 1 illustrates an LED bracket apparatus 10 in an embodiment of the present invention. Specifically, the bracket apparatus 10 is configured to be inserted into a high output light fixture, such as a street light, a parking area light, a parking garage light, or other like high output light fixture. The bracket apparatus comprises a base plate 12 having a first sidewall 14 and a second sidewall 16 extending from the base plate 12, forming channels 18, 20 (as illustrated in FIG. 2) for holding a plurality of arms therein, as described below. The bracket apparatus may further comprise a third sidewall 15 and a fourth sidewall 17 extending from the base plate 12, forming channels 19, 21 for holding a plurality of arms therein. The third sidewall 15, fourth sidewall 17, and channels 19, 21 may allow the base plate 12 to be orientated in an alternate embodiment shown by FIG. 7.

The base plate 12 comprises a first aperture 22 for holding a first high output LED module 24 therein, and a second aperture 26 for holding a second high output LED module 28 therein. It should be noted that although the embodiments of the present invention illustrate two high output LED modules 24, 28 disposed within first and second apertures 22, 26, the present invention may have a single aperture for holding a single high output LED module, or more than two apertures for holding more than two high output LED modules, and the present invention should not be limited as described herein.

The high output LED modules 24, 28, as described herein, may be any high output LED modules that may be utilized for street lighting, parking area lighting or the like, having the requisite output and color as desired. Particularly preferred LED modules that may be utilized for the present invention may be Philips Electronics Fortimo LED High Brightness Module, as described in more detail at http://www.ecat.lighting.philips.com/l/oem/led-systems/led-module-system/fortimo-led-high-bri ghtness-module/55940/cat/, which is incorporated herein by reference in its entirety. The high output LED module may be firmly attached to the base plate 12 via bolts or screws that may hold the LED modules through holes disposed in the base plate 12 on opposite sides of each of the apertures 22, 26. Driver cable apertures 30, 32 may further be disposed in the base plate 12 for routing driver cables (not shown) to the LED modules through the base plate 12.

Attached to the high output LED modules 24, 28 may be heat sinks 34 (shown in FIG. 2), that may aid in conducting heat away from the high output LED modules 24, 28 to protect the same from overheating. The heat sinks 34 may comprise a plurality of blades disposed in a fan-like manner to provide a large amount of surface area for heat to dissipate from the high output LED modules 24, 28. A first heat sink may be attached to the first LED module 24, and a second heat sink may be attached to the second LED module 28, and may be rigidly disposed on an opposite side of the base plate 12 than is illustrated in FIG. 1. In general, the heat sinks 34 are made of metal, such as aluminum, steel, copper, or any other material useful for conducting heat away from the LED modules 24, 28 to keep the same relatively cool. Additionally, heat dissipation may be assisted by dissipating the heat to the exterior of the box and then out to ambient air. In addition, it should be noted that most of the components of the embodiments described herein may be made of metal, such as, preferably, aluminum, steel, copper, or any other heat conducting material that may be useful for conducting heat away from the LED modules 24, 28.

Arms 36a, 36b, and 38a, 38b may extend from the base plate 12, disposed within the channels 18, 19, 20, 21 and may be extendable to allow the arms to traverse a relatively large distance or a relatively small distance, depending on the necessity of the space to fill within the light fixture. Specifically, the arms may preferably be slotted and engage bolts or screws that extend through the slots and into the holes in the first and second sidewalls 14, 16, and the third and fourth sidewalls 15, 17 respectively, allowing the arms 36, 36b and 38a, 38b to slide inwardly (toward the base plate 12) and outwardly (away from the base plate 12). Using channels 18, 20 allows the base plate 12 to be orientated in a first configuration, while using channels 19, 21 allows the base plate 12 to be orientated in a second configuration that differs from the first configuration by 90 degrees. To accomplish this, the slotted portions of the arms may overlap, and may be connected via the screws, bolts, or other means.

A first bridging portion 40 may connect the arms 36a, 36b to form a securing surface for securing the arms 36a, 36b to a side of a light fixture, and a second bridging portion 42 may connect the arms 38a, 38b to form a securing surface for securing the arms 38a, 38b to an opposite side of the light fixture. The first and second bridging portions 40, 42 may have a plurality of holes therein for securing a bolt or screw therein for securing to the sides of a light fixture.

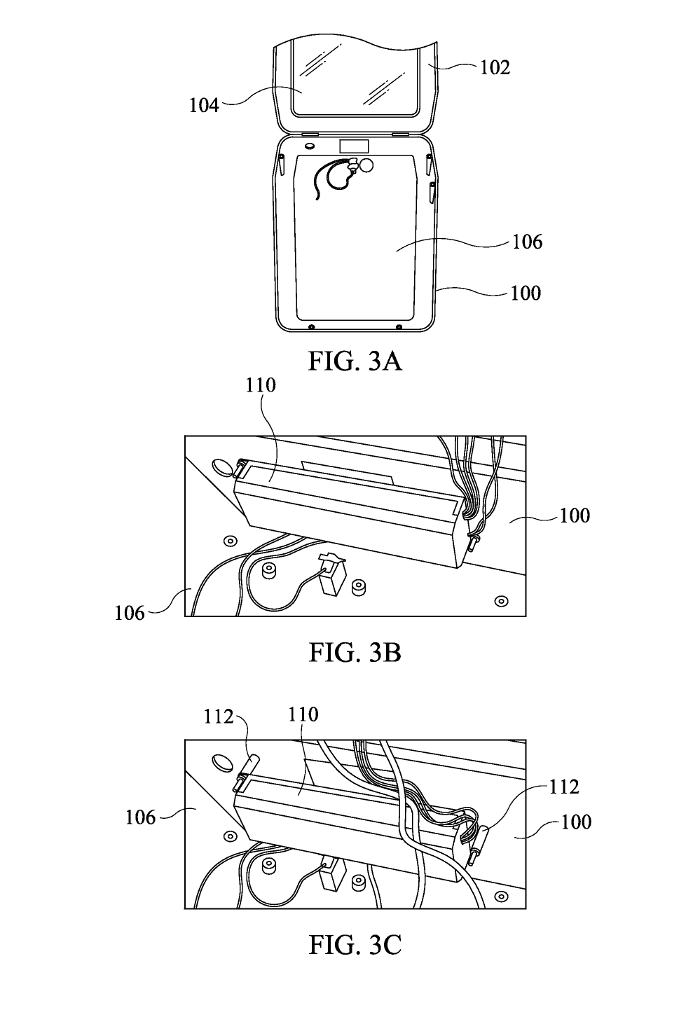

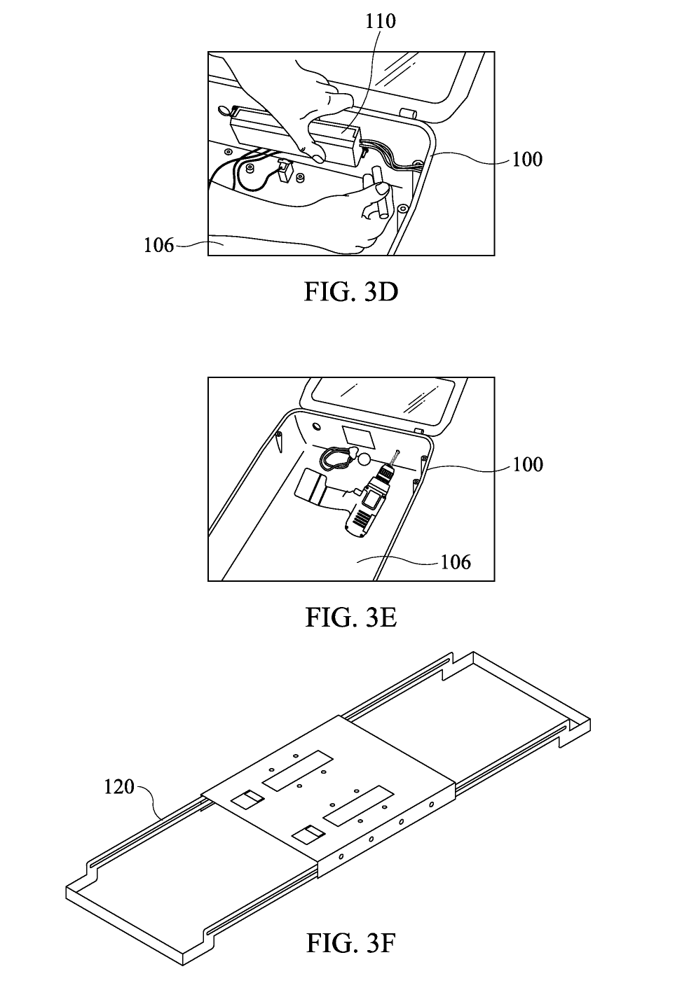

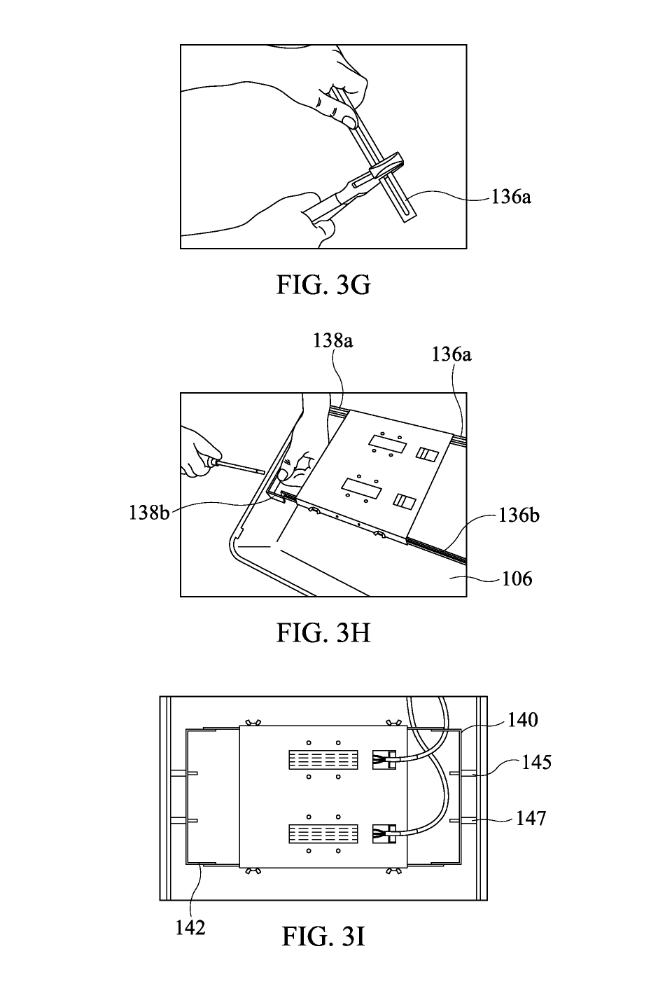

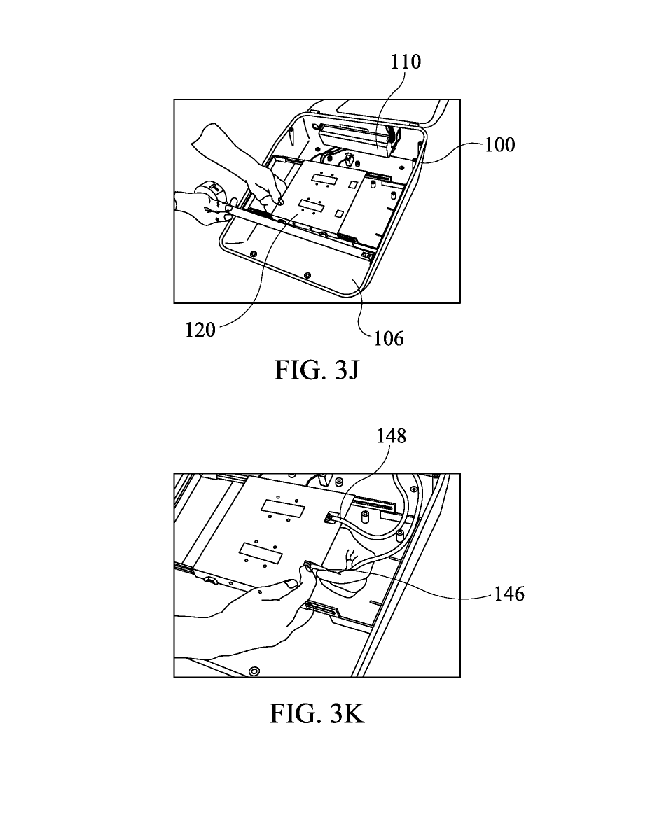

FIGS. 3A-3K illustrate a preferred method of using the apparatuses described herein in an embodiment of the present invention. FIG. 3A illustrates a light fixture 100 having its cover 102 and lens 104 opened to reveal an internal compartment 106 therein. For retrofitting the light fixture for use with an apparatus of the present invention, all existing light fixture components are preferably disconnected from the power leads and removed from the light fixture 100. The internal compartment 106 may be cleaned and inspected for any damage or defects that may be repairable.

An LED module driver 110 may be disposed within the light fixture 100, and may be fixed therein as shown in FIGS. 3B-3C. Specifically, FIG. 3B illustrates the driver mounted directly to a flat surface within the light fixture 100. Alternatively, FIG. 3C illustrates the driver 110 mounted with standoffs 112 if a flat surface is unavailable within the light fixture 100. The LED module driver 110 may drive the illumination of the LED modules, and may be connected to the light fixture power leads to provide requisite power for the same. Moreover, the driver 110 may preferably be multi-voltage, such that the driver will accept any voltage necessary to drive the LED modules, including 110V, 208V, 220V and 277V, for example. To connect the driver 110 to the light fixture 100, holes may be marked to the light fixture (as illustrated in FIG. 3D) and drilled (as illustrated in FIG. 3E).

An LED bracket apparatus 120 of the present invention, as illustrated in FIG. 3F, may then be connected within the light fixture. Generally, the LED bracket apparatus 120 may be mounted within the light fixture 100 to flat, clean surfaces, preferably using all available mounting bracket holes to ensure secure connection. Moreover, the LED modules should be mounted so that they are preferably not too close to the fixture lens 104. The distance within which the LED bracket apparatus 120 is to be mounted is preferably measured, and arms 136a, 136b and 138a, 138b are preferably cut down to size so that the LED bracket apparatus 120 fits within the distance measured, as illustrated in FIG. 3G. First and second bridging portions 140, 142 may then be mounted to the sides, or other surface, of the light fixture 100, as illustrated in FIG. 3H. The arms 136a, 136b and 138a, 138b may be secured together via nuts through the slots, such as with wing nuts, as illustrated in FIGS. 3H and 3I. Of course, any other securing means may be used, and the invention should not be limited as described herein. The LED modules, as illustrated in FIG. 3I, may be centered within the light fixture 100. Finally, driver cables 144, 146 may be secured to the LED modules, as illustrated in FIG. 3J, connecting the driver 110 to the LED modules.

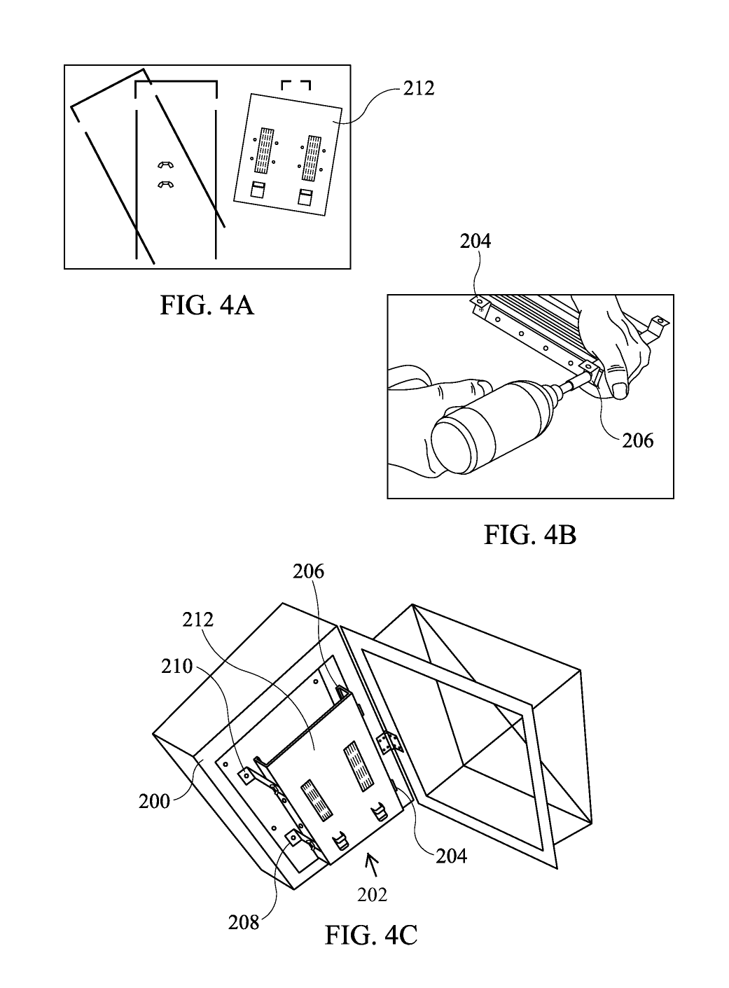

In an alternative embodiment of the present invention, illustrated in FIGS. 4A-4C, an LED bracket apparatus 202 of the present invention may be attached to a light fixture 200 via L-brackets instead of the arms 36a, 36b and 38a, 38b or 136a, 136b and 138a, 138b, as described above. Specifically, the arms may be removed from a base plate 212, as shown in FIG. 4A, and L-brackets 204, 206, 208, 210 may be attached on a first sidewall 214 and a second sidewall 216 of the base plate 212, as illustrated in FIG. 4B. The LED bracket apparatus 202 may then be fixed within the light fixture 200 via the L-brackets 204, 206, 208, 210 as illustrated in FIG. 4C. Alternatively, a plurality of L-brackets 205, 207, 209, 211 may be fixed on a third sidewall 215 and a fourth sidewall 217 of the baseplate 212.

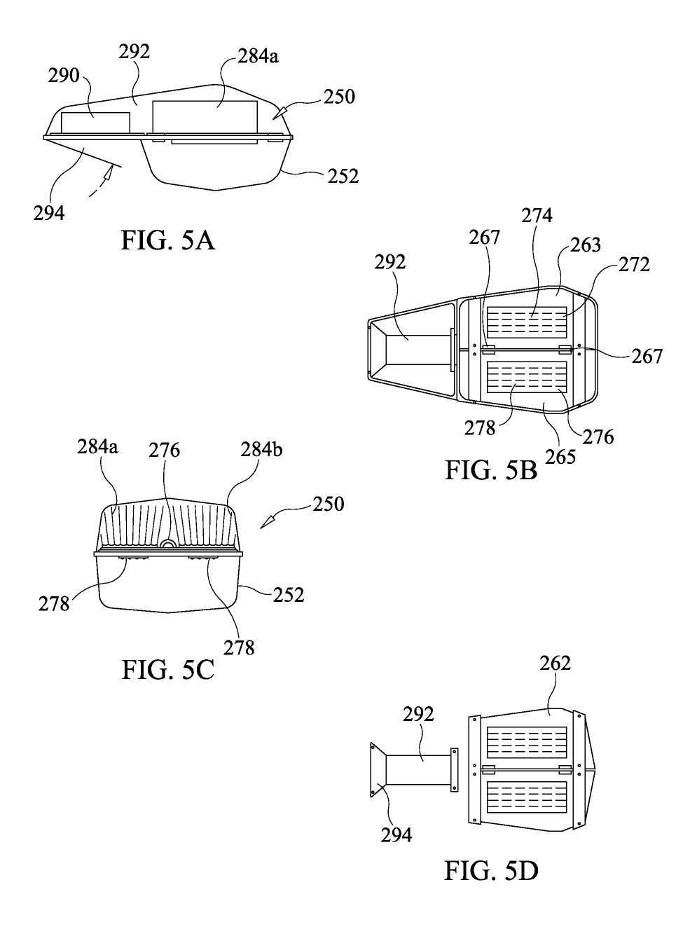

In a further alternate embodiment of the present invention, an LED bracket apparatus 250 is illustrated in FIGS. 5A-5D. The LED bracket apparatus 250 is particularly preferred for streetlights having a relatively small space within for mounting the LED modules therein. To accommodate the space within the relatively small light fixture 252, a foldable base plate 262 may be utilized having a first base plate portion 263 and a second base plate portion 265 disposed, generally, side-by-side and having one or more hinges 267 disposed therebetween for holding the same. Disposed in first and second openings 272, 276 in the first and second base plate portions 263, 265 may be first and second LED modules 274, 278, mounted therein as described above with reference to the previous embodiments.

As with previous embodiments, heat sinks 284a, 284b may be disposed on a top side of the LED modules 274, 278 for conducting heat away from the LED modules 274, 278, keeping the same relatively cool when in use. Of course, many or all of the components of the embodiments described herein may be made from a conducting material, such as metal or the like for effectively conducting heat from the LED modules 274, 278.

Rigid straps 275a, 275b may be disposed on opposite ends of the foldable base plate 262, which may be mounted to foldable base plate 262 and to the light fixture 252 to rigidly dispose the foldable base plate 262 within the light fixture 252, via bolts, screws, or other attaching means.

A driver 290 may be disposed within the light fixture 252, as shown in FIG. 5A, in a compartment 292 disposed rearwardly of the foldable base plate 262. The compartment 292 may have a door panel 294 for opening the same, and the driver 290 may be mounted therein. The driver 290 may be connected to the power leads of the light fixture 252, and further may be connected to the LED modules 274, 278 via driver cables (not shown) as apparent to one of ordinary skill in the art.

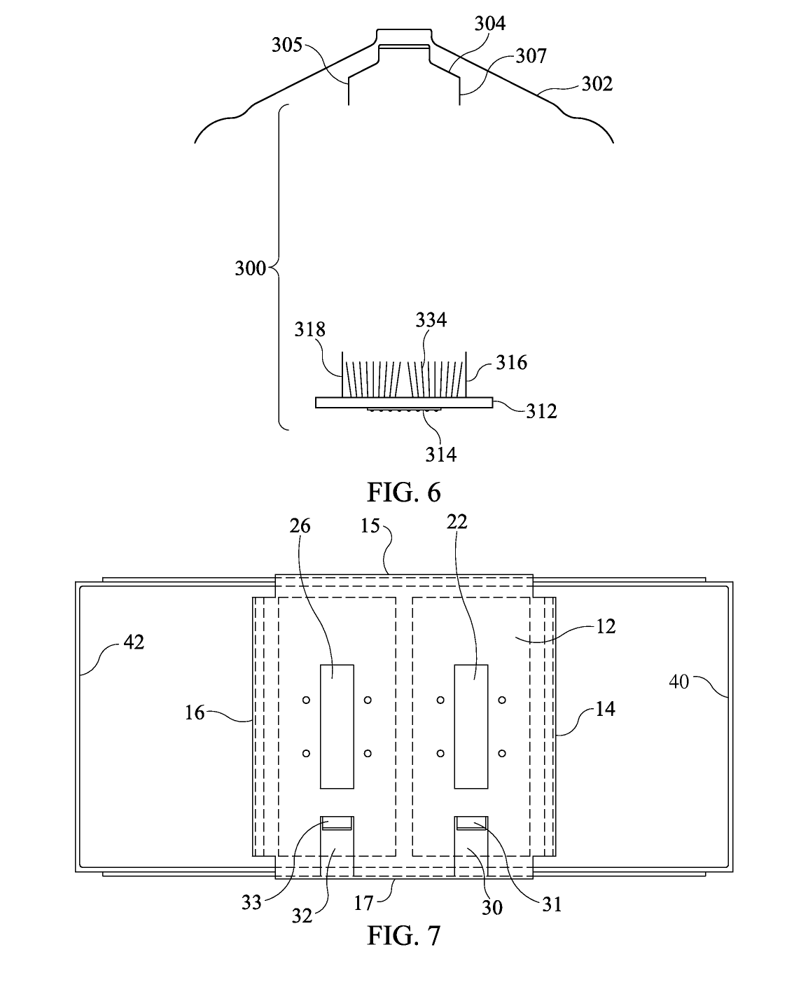

In an alternate embodiment of the present invention, shown in FIG. 6, an LED bracket apparatus 300 may be disposed within a downward round light fixture 302. Generally, after removal of the existing light components of the downward round light fixture 302, a first bracket portion 304 may be attached to the round light fixture, and generally shaped to fit therein, firmly attached via bolts, screws or other like connecting means. The first bracket portion 304 may have downwardly extending legs 305, 307. A base plate 312 having one or more LED modules 314 disposed thereon with one or more heat sinks 334 connected thereto, as described above with reference to other embodiments, may have first and second legs 316, 318 rigidly attached to base plate 312 and extending upwardly to engage first bracket portion the downwardly extending legs 305, 307 on the first bracket portion 304. The first and second legs 316, 318 may be connected to the first bracket portion 304 with bolts, screws or other like attaching means for rigidly connecting the same, and for securing the same within the light fixture. A driver (not shown) may be firmly attached within the round light fixture as needed for connecting to the power leads and for driving the one or more LED modules 314.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for retrofitting a light fixture having a shape and size with one or more LED modules, comprising:
a baseplate having a first sidewall, a second sidewall, and a surface, wherein the surface has at least one aperture, the first and second sidewalls extending away from the surface, each incorporating a sleeve for holding a bracket arm;
at least one LED module disposed in the at least one aperture;
a first bracket arm disposed beneath the baseplate and moveably held within the sleeve of the first sidewall; and
a second bracket arm disposed beneath the baseplate and moveably held within the sleeve of the second sidewall;
wherein the first bracket arm and the second bracket arm are adjustable toward the baseplate and away from the baseplate to fit the size and shape of the light fixture.

2. The apparatus of claim 1 further comprising a third sidewall and a fourth sidewall.

3. The apparatus of claim 1 wherein the first bracket arm is connected to the first sidewall and the second bracket arm is connected to the second sidewall.

4. The apparatus of claim 2 wherein the first bracket arm is connected to the third sidewall and the second bracket arm is connected to the fourth sidewall.

5. The apparatus of claim 1 wherein the LED module comprises at least one high output LED.

6. The apparatus of claim 1 wherein the first bracket arm is connected to the first sidewall by a connector selected from the group consisting of a screw, a bolt, a rivet, a nail, a glue, a staple, a pin, a wing nut, a clip, and any combination thereof.

7. The apparatus of claim 1 wherein the second bracket arm is connected to the second sidewall by a connector selected from the group consisting of a screw, a bolt, a rivet, a nail, a glue, a staple, a pin, a wing nut, a clip, and any combination thereof.

8. The apparatus of claim 1 further comprising a LED driver electrically connected to the at least one LED module.

9. The apparatus of claim 1 further comprising at least one heat sink disposed on a back side of the at least one LED module.

10. The apparatus of claim 1 where in the baseplate is foldable.

11. A system for retrofitting a light fixture, the system comprising
a light fixture having a size and a shape;
an apparatus for retrofitting the light fixture comprising a baseplate having a first sidewall, a second sidewall, a third sidewall, a fourth sidewall, and a surface, wherein the surface has at least one aperture, and further wherein the first, second, third and fourth sidewalls extend away from the surface, each having a sleeve for holding a bracket arm therein;
a first bracket arm disposed within the sleeve of the first sidewall;
a second bracket arm disposed within the sleeve of the second sidewall;
at least one LED module disposed in the at least one aperture of the apparatus; and
an LED driver for powering the at least one LED module electrically connected to the at least one LED module;
wherein the apparatus is disposed within the light fixture and the first bracket arm and the second bracket arm are adjusted to fit the size and the shape of the light fixture.

12. The system of claim 11 further comprising at least one heat sink disposed on a back side of the at least one LED module.

13. The system of claim 11 wherein the first bracket arm is connected to the first sidewall and the second bracket arm is connected to the second sidewall, wherein the first sidewall and the second sidewall are disposed on opposite sides of the surface.

14. The system of claim 11 wherein the first bracket arm is connected to the third sidewall and the second bracket arm is connected to the fourth sidewall, wherein the third sidewall and the fourth sidewall are disposed on opposite sides of the surface.

15. The system of claim 11 wherein the LED module comprises at least one high output LED.

16. The system of claim 11 wherein the first bracket arm and second bracket arm are connected to the baseplate by a connector selected from the group consisting of a screw, a bolt, a rivet, a nail, a glue, a staple, a pin, a wing nut, a clip, and any combination thereof.

17. A method for retrofitting a light fixture, the method comprising the steps of:
providing a light fixture having a power source;
providing an apparatus for retrofitting the light fixture comprising a baseplate having a first sidewall, and a second sidewall, and a surface, wherein the surface has at least one aperture, at least one LED module disposed in the at least one aperture, the first and second sidewalls extending away from the surface, each having a sleeve for holding a bracket arm therein;
providing a first bracket arm moveably held in the first sidewall and a second bracket arm moveably held in the second sidewall, wherein the first bracket arm and the second bracket arm are adjustable toward the baseplate and away from the baseplate to fit the size and shape of the light fixture;
adjusting the first bracket arm and the second bracket arm to fit the light fixture; and
attaching the apparatus inside the light fixture.

18. The method of claim 17 further comprising the steps of:
connecting the first bracket arm to the first sidewall; and
connecting the second bracket arm to the second sidewall.

19. The method of claim 17 further comprising the steps of:
providing a third sidewall extending away from the surface;
connecting the first bracket arm to the third sidewall;
providing a fourth sidewall extending away from the surface; and
connecting the second bracket arm to the fourth sidewall.

20. The method of claim 6 further comprising the steps of:
installing a LED driver within the light fixture;
connecting the LED driver to the power source; and
connecting the LED driver to at least one LED module.
